(19) United States
(12) Patent Application Publication
(10) Pub. No.: US 2026/0246045 A1
(43) Pub. Date: Aug. 20, 2026

(54) CIRCUIT PROTECTION UNIT AND CONDUCTIVE MODULE

(71) Applicant: YAZAKI CORPORATION, Tokyo (JP)

(72) Inventors: Katsunori Sato, Makinohara-shi (JP); Mariko Nakagawa, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/537,520

(22) Filed: Feb. 12, 2026

(30) Foreign Application Priority Data
Feb. 14, 2025 (JP) 2025-022151

(51) Int. Cl. H01M 50/209; H01M 10/42; H01M 10/48

(52) U.S. Cl. CPC H01M 50/209; H01M 10/4257; H01M 10/482

(57) ABSTRACT

A circuit protection unit applied to a conductive module includes a circuit protection component, a first terminal fitting that has a first electrical connection portion electrically connected to the circuit protection component, a second terminal fitting that has a second electrical connection portion electrically connected to the circuit protection component, a support member that has insulating properties and is formed in a plate shape and on which the first electrical connection portion and the second electrical connection portion are placed, and the coating resin portion that has insulating properties, is provided on the support member, and encloses the first electrical connection portion, the second electrical connection portion, and the circuit protection component installed across the first electrical connection portion and the second electrical connection portion.

### CROSS-REFERENCE TO RELATED APPLICATION(S)

The present application claims priority to and incorporates by reference the entire contents of Japanese Patent Application No. 2025-022151 filed in Japan on February 14, 2025.

### BACKGROUND OF THE INVENTION

### 1. Field of the Invention

The present invention relates to a circuit protection unit and a conductive module.

### 2. Description of the Related Art

In a battery module in which a plurality of battery cells are arranged, a conductive module electrically connects the plurality of battery cells using a plurality of connection conductors. Then, the conductive module electrically connects each connection conductor to a battery monitoring unit that monitors a battery state of the battery cell using a wiring component such as an electric wire. For example, Japanese Patent Application Laid-open No. JP 2020 - 119 651 A discloses this type of conductive module. In such a conductive module, a combination of a pair of a connection conductor and a conductor portion of a wiring component is provided for each connection conductor, and a circuit protection component such as a fuse may be interposed between the connection conductor and the conductor portion of the wiring component in each combination. For example, Japanese Patent No. 7 561 318 B2 discloses a circuit protection unit (constituted by a chip fuse, a pair of terminal fittings, and a resin portion) applied to the conductive module.

Incidentally, in the circuit protection unit of the related art, connection portions between the circuit protection component and the pair of terminal fittings are surrounded by the frame-shaped resin portion, but there is still room for further improvement in a structure for protecting the connection portions between the circuit protection component and the pair of terminal fittings.

### SUMMARY OF THE INVENTION

The present invention has been made in view of the above circumstances, and an object thereof is to provide a circuit protection unit and a conductive module capable of appropriately protecting connection portions between a circuit protection component and a pair of terminal fittings.

In order to achieve the above mentioned object, a circuit protection unit according to one aspect of the present invention includes a circuit protection component that fuses a fusible portion when an overcurrent flows between a first electrical connection target and a second electrical connection target; a first terminal fitting that has a first electrical connection portion electrically connected to a first electrode of the circuit protection component and is electrically connected to the first electrical connection target; a second terminal fitting that has a second electrical connection portion electrically connected to a second electrode of the circuit protection component and is electrically connected to the second electrical connection target; a support member that has insulating properties and is formed in a plate shape and on which the first electrical connection portion and the second electrical connection portion are placed; and a coating resin portion that has insulating properties, is provided on the support member, and encloses the first electrical connection portion, the second electrical connection portion, and the circuit protection component installed across the first electrical connection portion and the second electrical connection portion.

In order to achieve the above mentioned object, a conductive module according to another aspect of the present invention includes a connection conductor electrically connected to an electrode terminal of a battery cell constituting a battery module; and a circuit protection unit that electrically connects the connection conductor to a battery monitoring unit that monitors a battery state of the battery cell, wherein the circuit protection unit includes: a circuit protection component that fuses a fusible portion when an overcurrent flows between the connection conductor and the battery monitoring unit; a first terminal fitting that has a first electrical connection portion electrically connected to a first electrode of the circuit protection component and is electrically connected to the connection conductor; a second terminal fitting that has a second electrical connection portion electrically connected to a second electrode of the circuit protection component and is electrically connected to the battery monitoring unit; a wiring component that is interposed between the second terminal fitting and the battery monitoring unit and includes a conductor portion having one end electrically connected to the second terminal fitting and another end electrically connected to the battery monitoring unit; a support member that has insulating properties and is formed in a plate shape and on which the first electrical connection portion and the second electrical connection portion are placed; and a coating resin portion that has insulating properties, is provided on the support member, and encloses the first electrical connection portion, the second electrical connection portion, and the circuit protection component installed across the first electrical connection portion and the second electrical connection portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a circuit protection unit and a conductive module according to a first embodiment;

FIG. 2 is a schematic view illustrating a schematic configuration of a battery module and a connection conductor that electrically connects electrode terminals of battery cells constituting the battery module;

FIG. 3 is a perspective view illustrating a schematic configuration of the circuit protection unit according to a first embodiment;

FIG. 4 is a plan view for explaining a coating resin portion provided in the circuit protection unit according to the first embodiment;

FIG. 5 is a perspective view illustrating a schematic configuration of a circuit protection unit according to a second embodiment;

FIG. 6 is a perspective view illustrating a schematic configuration of a circuit protection unit according to a third embodiment; and

FIG. 7 is a perspective view illustrating a schematic configuration of a circuit protection unit according to a fourth embodiment.

### DETAILED DESCRIPTION OF THE PREFERRED EMBODIMENTS

Hereinafter, embodiments according to the present invention will be described in detail with reference to the drawings. Note that the present invention is not limited by the embodiments. In addition, constituent elements in the following embodiments include those that can be easily replaced by those skilled in the art or those that are substantially the same.

### First Embodiment

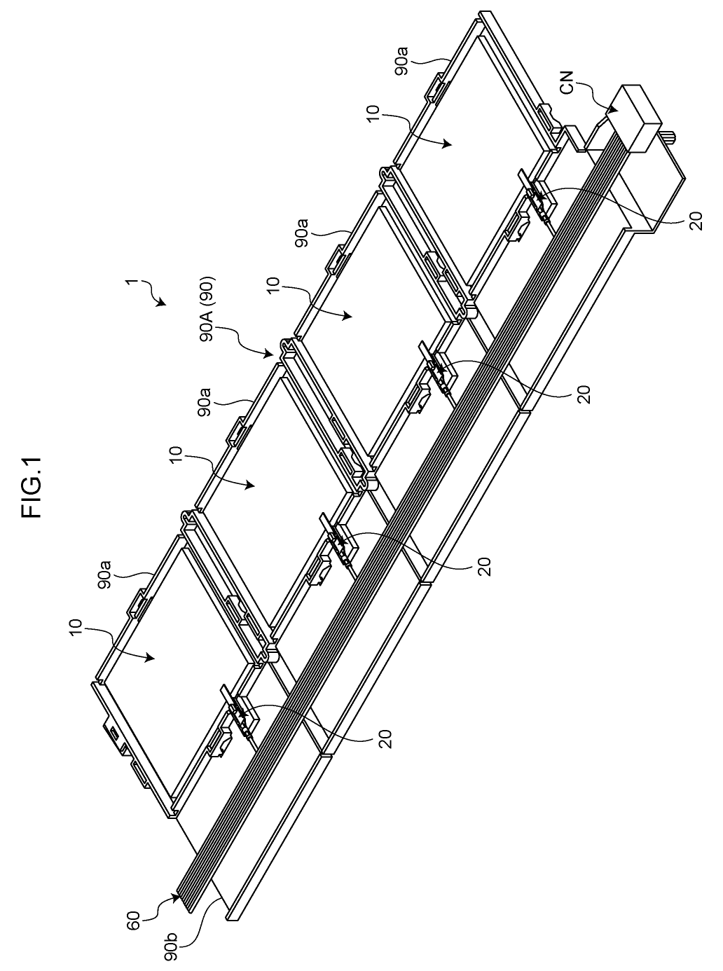

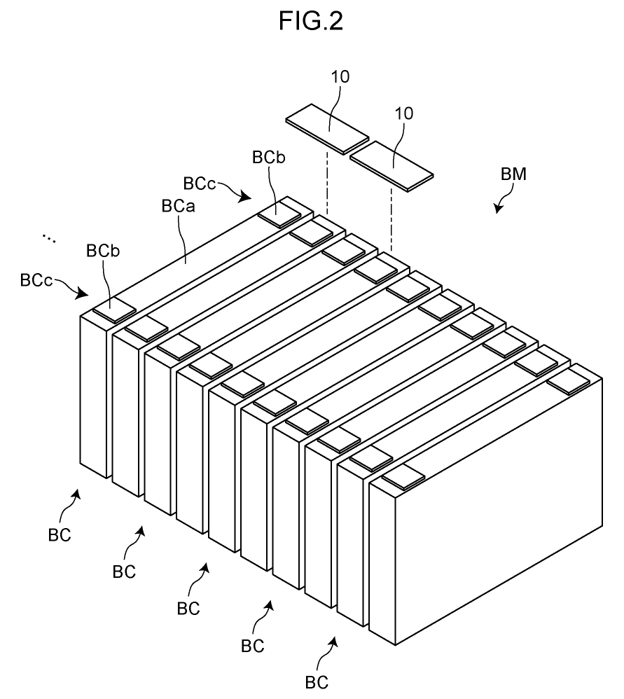

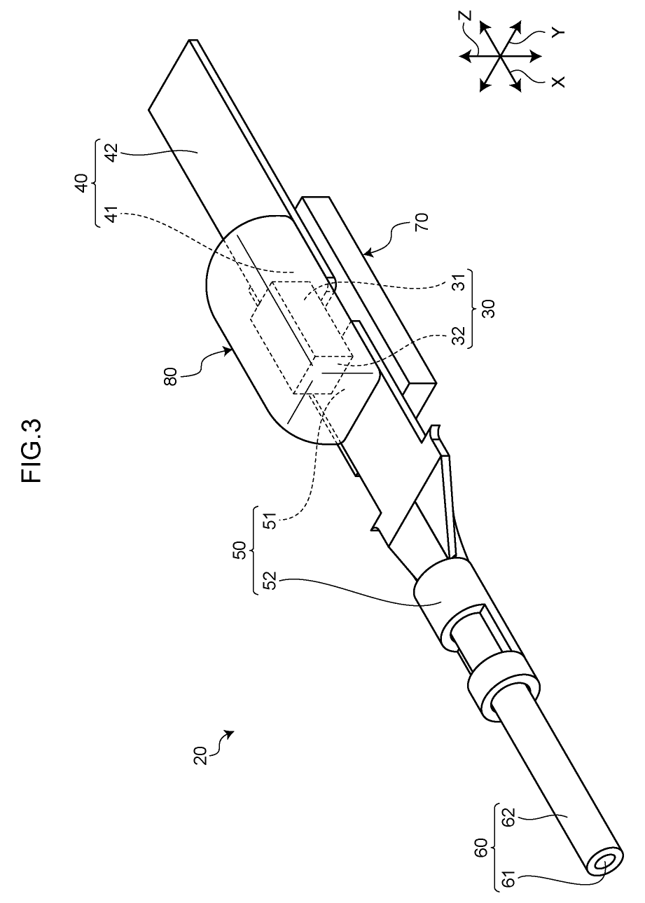

A conductive module 1 illustrated in FIG. 1 is assembled to a battery module BM (see FIG. 2) in which a plurality of battery cells BC are arranged, and electrically connects the battery module BM and a battery monitoring unit (not illustrated) to cause the battery monitoring unit to monitor a battery state of the battery cell BC. A battery pack including the conductive module 1 and the battery module BM is mounted on, for example, a vehicle (BEV: Battery Electric Vehicle, HEV: Hybrid Electric Vehicle, etc.) including a rotary machine as a drive source, and supplies power to the rotary machine. A circuit protection unit 20(see FIGS. 1 and 3) applied to such a conductive module 1 includes a circuit protection component 30 such as a fuse, a pair of terminal fittings (a first terminal fitting 40 and a second terminal fitting 50) electrically connected to the circuit protection component 30, and a support member 70 formed in a plate shape on which the pair of terminal fittings is placed. The circuit protection unit 20 and the conductive module 1 of the present embodiment realize a configuration capable of appropriately protecting connection portions between the circuit protection component 30 and the pair of terminal fittings by providing a coating resin portion 80 on the plate-shaped support member 70. Hereinafter, each configuration of the circuit protection unit 20 and the conductive module 1 will be described in detail with reference to FIGS. 1 to 4.

In the battery cell BC of the present embodiment, as illustrated in FIG. 2, a cell body BCa is formed in a parallelepiped shape having six outer wall surfaces. The battery cells BC are disposed such that the outer wall surfaces face each other, and positive and negative electrode terminals BCb are provided on one of the six outer wall surfaces of the cell body BCa. Therefore, in the battery module BM of the present embodiment, two electrode terminal groups BCc in each of which a plurality of electrode terminals BCb are arranged in an arrangement direction of the battery cells BC are provided on one plane.

As illustrated in FIG. 2, the electrode terminal BCb of the present embodiment is formed in a flat plate shape. As illustrated in FIG. 2, the electrode terminal BCb is electrically connected to a connection conductor 10 by joining the connection conductor 10, which will be described below, to the electrode terminal BCb by laser welding or the like. The electrode terminal BCb may be formed in a pole shape having a male screw portion. In this case, a female screw member is screwed to the male screw portion of the electrode terminal BCb, and the connection conductor 10 is screwed and fixed to the electrode terminal BCb, whereby the electrode terminal BCb and the connection conductor 10 are electrically connected.

In the following description, among a first direction, a second direction, and a third direction intersecting each other, the first direction is referred to as an "axial direction X ", the second direction is referred to as a "width direction Y", and the third direction is referred to as a "height direction Z ". Here, the axial direction X, the width direction Y, and the height direction Z are orthogonal to each other. The axial direction X typically corresponds to a direction in which a first electrical connection portion 41 of the first terminal fitting 40 and a second electrical connection portion 51 of the second terminal fitting 50 are connected, an extending direction of the support member 70, or the like. The width direction Y corresponds to a width direction of the first electrical connection portion 41, a width direction of the second electrical connection portion 51, a width direction of the support member 70, or the like. The height direction Z typically corresponds to a plate thickness direction of the first electrical connection portion 41, a plate thickness direction of the second electrical connection portion 51, a plate thickness direction of the support member 70, or the like.

As illustrated in FIG. 1 and the like, the conductive module 1 includes the connection conductor 10 electrically connected to the electrode terminal BCb of the battery cell BC constituting the battery module BM, and the circuit protection unit 20 that electrically connects the connection conductor 10 to the battery monitoring unit (not illustrated) that monitors a battery state of the battery cell BC.

The connection conductor 10 is a conductive component formed of a material having conductivity such as a metal. The connection conductor 10 in the present embodiment is a plate-shaped conductive component made of a metal which is called a bus bar, and for example, each portion is integrally formed by pressing a metal plate in accordance with a shape corresponding to each portion. As illustrated in FIGS. 1 and 2, the connection conductor 10 is formed in a rectangular flat plate shape, and is joined to the electrode terminals BCb of the adjacent battery cells BC to electrically connect the battery cells BC to each other.

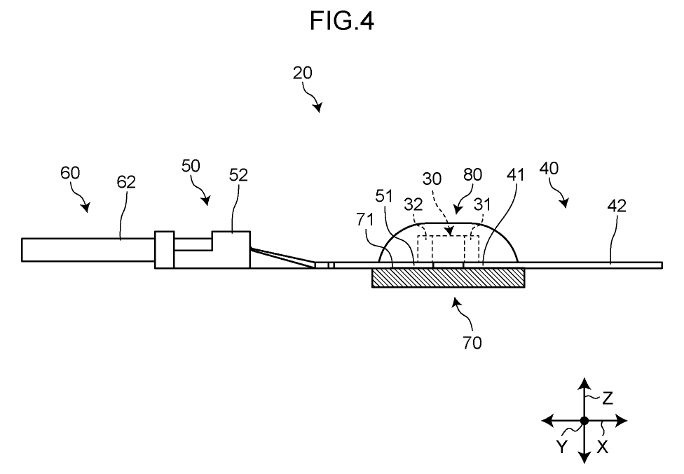

As illustrated in FIGS. 3 and 4, the circuit protection unit 20 includes the circuit protection component 30 that fuses a fusible portion when an overcurrent flows between the connection conductor 10 as a first electrical connection target and the battery monitoring unit as a second electrical connection target, the first terminal fitting 40 and the second terminal fitting 50 electrically connected to the circuit protection component 30, and a wiring component 60 interposed between the second terminal fitting 50 and the battery monitoring unit. As illustrated in FIGS. 3 and 4, the circuit protection unit 20 further includes the support member 70 on which the first electrical connection portion 41 of the first terminal fitting 40 and the second electrical connection portion 51 of the second terminal fitting 50 are placed, and the coating resin portion 80 provided on the support member 70 and enclosing the first electrical connection portion 41, the second electrical connection portion 51, and the circuit protection component 30 installed across the first electrical connection portion 41 and the second electrical connection portion 51.

The circuit protection component 30 is a component that protects an electric device by fusing itself to cut off an electric circuit when an overcurrent flows through the circuit. The circuit protection component 30 in the present embodiment is a parallelepiped-shaped chip fuse having a fusible portion, and as illustrated in FIGS. 3 and 4, includes a first electrode 31 electrically connected to the first terminal fitting 40 disposed on a side of the connection conductor 10, and a second electrode 32 electrically connected to the second terminal fitting 50 disposed on a side of the battery monitoring unit.

The first electrode 31 is an electrode provided on one end side in the axial direction X of the circuit protection component 30, and the second electrode 32 is an electrode provided on the other end side in the axial direction X of the circuit protection component 30, that is, on a side opposite to the first electrode 31 in the axial direction X. In the circuit protection component 30 of the present embodiment, the first electrode 31 and the second electrode 32 are linearly disposed in the axial direction X, the first electrode 31 is electrically connected to the first terminal fitting 40, and the second electrode 32 is electrically connected to the second terminal fitting 50, and thus the first terminal fitting 40 and the second terminal fitting 50 can be linearly connected in the axial direction X.

As described above, the circuit protection component 30 may be configured as a chip fuse having a fusible portion, or may be configured as a pattern fuse in which a wiring pattern having a fusible portion is provided on a printed circuit board (for example, a flexible printed circuit board).

The first terminal fitting 40 is a conductive component formed of a material having conductivity such as a metal. The first terminal fitting 40 in the present embodiment is a plate-shaped component made of a metal, and for example, each portion is integrally formed by pressing a metal plate in accordance with a shape corresponding to each portion. As illustrated in FIGS. 3 and 4, the first terminal fitting 40 includes the first electrical connection portion 41 electrically connected to the first electrode 31 of the circuit protection component 30 and a first electrical connection target-connection portion electrically connected to the first electrical connection target. In the present embodiment, the first electrical connection target-connection portion will be referred to as a conductor connection portion 42.

As illustrated in FIG. 3, the first electrical connection portion 41 is formed in a rectangular flat plate shape. The width (length in the width direction Y) of the first electrical connection portion 41 is set to a length allowing the first electrical connection portion 41 to be placed on the support member 70 which will be described below, and is configured to be narrower than the width (length in the width direction Y) of the support member 70. In the present embodiment, the width (length in the width direction Y) of the first electrical connection portion 41 is configured to be equal to the width (length in the width direction Y) of the conductor connection portion 42 as illustrated in FIG. 3. As illustrated in FIGS. 3 and 4, when the first electrode 31 of the circuit protection component 30 is placed on the surface of the first electrical connection portion 41 while the first electrical connection portion is placed on the support member 70, the first electrode 31 is joined to the first electrical connection portion by laser welding, soldering, or the like, and thus the first electrical connection portion 41 is electrically connected to the circuit protection component 30.

As illustrated in FIGS. 3 and 4, the conductor connection portion 42 is formed in a rectangular flat plate shape. Therefore, the conductor connection portion 42 is placed on the connection conductor 10 so as to overlap planes, and is electrically connected to the connection conductor 10 as the first electrical connection target when the connection conductor 10 is joined to the conductor connection portion by laser welding, ultrasonic joining, or the like. As illustrated in FIGS. 3 and 4, the first electrical connection portion 41 and the conductor connection portion 42 described above are provided adjacent to each other, and thus the first terminal fitting 40 is formed in a rectangular flat plate shape.

The second terminal fitting 50 is a conductive component formed of a material having conductivity such as a metal. The second terminal fitting 50 in the present embodiment is a component three-dimensionally formed of a plate-shaped material made of a metal, and for example, each portion is integrally formed by pressing a metal plate in accordance with a shape corresponding to each portion. As illustrated in FIGS. 3 and 4, the second terminal fitting 50 includes the second electrical connection portion 51 electrically connected to the second electrode 32 of the circuit protection component 30 and a second electrical connection target-connection portion electrically connected to the second electrical connection target. In the present embodiment, the second electrical connection target-connection portion will be referred to as a wiring connection portion 52.

As illustrated in FIG. 4, the second electrical connection portion 51 is formed in a rectangular flat plate shape. The width (length in the width direction Y) of the second electrical connection portion 51 is set to a length allowing the second electrical connection portion 51 to be placed on the support member 70 which will be described below, and is configured to be narrower than the width (length in the width direction Y) of the support member 70. As illustrated in FIGS. 3 and 4, when the second electrode 32 of the circuit protection component 30 is placed on the surface of the second electrical connection portion 51 while the second electrical connection portion is placed on the support member 70, the second electrode 32 is joined to the second electrical connection portion 51 by laser welding, soldering, or the like, and thus the second electrical connection portion 51 is electrically connected to the circuit protection component 30.

As illustrated in FIG. 3, the wiring connection portion 52 is formed in a tubular shape, and is electrically connected to the wiring component 60 which is the second electrical connection target by crimping a conductor portion 61 of the wiring component 60, which will be described below. In addition, as illustrated in FIG. 3, since the second electrical connection portion 51 and the wiring connection portion 52 described above are provided adjacent to each other, the second terminal fitting 50 can lead out the wiring component 60 in a direction in which the second electrical connection portion 51 and the wiring connection portion 52 are adjacent to each other, that is, the axial direction X which is an extending direction of the second electrical connection portion 51 and the wiring connection portion 52. The shape of the wiring connection portion 52 may be a tubular shape as illustrated in FIG. 3 and the like, or may be configured by a pair of barrel pieces.

As illustrated in FIG. 3, the wiring component 60 is an insulated electric wire including the conductor portion 61 (core wire) which has conductivity, one end of which is electrically connected to the second terminal fitting 50, and the other end of which is electrically connected to the battery monitoring unit, and an insulating coating portion 62 having insulating properties, and the conductor portion 61 is coated with the insulating coating portion 62. The conductor portion 61 here is a plurality of strands having conductivity. Further, the insulating coating portion 62 is formed by, for example, extruding a resin material having insulating properties (PP, PVC, crosslinked PE, or the like which is appropriately selected in consideration of abrasion resistance, chemical resistance, heat resistance, and the like.) or the like. The conductor portion 61 may be formed by twisting a plurality of strands or bundling the plurality of strands.

As illustrated in FIG. 3, the wiring component 60 extends linearly in the axial direction X, a cross-sectional shape of the conductor portion 61 (cross-sectional shape in a direction intersecting the axial direction X, which is an extending direction of the wiring component 60) is a substantially circular shape, a cross-sectional shape of the insulating coating portion 62 is a substantially annular shape, and a cross-sectional shape as a whole is a substantially circular shape. In addition, in the wiring component 60, the insulating coating portion 62 is peeled off at at least one terminal, and a conductor exposed portion where the conductor portion 61 is exposed from a terminal of the insulating coating portion 62 is crimped to the wiring connection portion 52 of the second terminal fitting 50, whereby the wiring connection portion 52 is electrically connected to one end of the conductor portion 61. Note that the wiring component 60 may be a flat wiring member such as a flexible printed circuit board in which the conductor portion 61 is formed as a wiring pattern.

The support member 70 is formed of a material having insulating properties such as a synthetic resin, and supports the connection portions between the circuit protection component 30 and the pair of terminal fittings (the first terminal fitting 40 and the second terminal fitting 50), that is, a portion where the first electrode 31 of the circuit protection component 30 and the first electrical connection portion 41 of the first terminal fitting 40 are connected, and a portion where the second electrode 32 of the circuit protection component 30 and the second electrical connection portion 51 of the second terminal fitting 50 are connected.

As illustrated in FIGS. 3 and 4, the support member 70 is a plate-shaped member extending in the axial direction X and the width direction Y and having the height direction Z as the plate thickness direction. The support member 70 of the present embodiment is formed in a rectangular flat plate shape, and is provided with an installation surface 71 on which the first electrical connection portion 41 of the first terminal fitting 40 and the second electrical connection portion 51 of the second terminal fitting 50 are placed (see FIG. 4). Therefore, in the support member 70 of the present embodiment, the circuit protection component 30 is placed on the first electrical connection portion 41 of the first terminal fitting 40 and the second electrical connection portion 51 of the second terminal fitting 50 is placed on the installation surface 71, and thus a portion where the first electrode 31 of the circuit protection component 30 and the first electrical connection portion 41 of the first terminal fitting 40 are connected, and a portion where the second electrode 32 of the circuit protection component 30 and the second electrical connection portion 51 of the second terminal fitting 50 are connected can be placed.

The coating resin portion 80 encloses the circuit protection component 30, the first electrical connection portion 41, and the second electrical connection portion 51 to suppress energization between the first electrical connection portion 41 and the second electrical connection portion 51. The coating resin portion 80 can also function as a fixing member that fixes the circuit protection component 30, the first electrical connection portion 41, and the second electrical connection portion 51 onto the support member 70 by being fixed to the support member 70. The coating resin portion 80 is made of, for example, a solidified material obtained by curing a liquid resin material (so-called potting material) dropped so as to enclose the circuit protection component 30, the first electrical connection portion 41, and the second electrical connection portion 51. As the resin material forming the coating resin portion 80, it is desirable to use a resin material having a viscosity that allows the resin material to be retained around the circuit protection component 30, the first electrical connection portion 41, and the second electrical connection portion 51 until the resin material is cured after being dropped so as to enclose the circuit protection component 30, the first electrical connection portion 41, and the second electrical connection portion 51 placed on the support member 70.

Note that the support member 70 described above can also function as a member on which the connection portions between the circuit protection component 30 and the pair of terminal fittings (the first terminal fitting 40 and the second terminal fitting 50) can be placed. However, for example, by providing a pair of positioning pins on a side of the support member 70, providing positioning holes on sides of the terminal fittings (the first terminal fitting 40 and the second terminal fitting 50), and inserting the respective positioning pins into the positioning holes, the support member can also function as a member capable of determining a positional relationship between the first terminal fitting 40 and the second terminal fitting 50 (such as a distance between the first terminal fitting 40 and the second terminal fitting 50). In addition, the support member 70 can also function as a member that can absorb heat generated at the connection portions between the circuit protection component 30 and the pair of terminal fittings and radiate the heat to the outside so as to curb the heat from being confined in the connection portions. Therefore, by providing the coating resin portion 80 on the plate-shaped support member 70, the circuit protection unit 20 of the present embodiment can improve the degree of freedom in manufacturing as compared with the conventional circuit protection unit, and can protect the connection portions between the circuit protection component 30 and the pair of terminal fittings in a more appropriate state.

In addition to the connection conductor 10 and the circuit protection unit 20, the conductive module 1 described above further includes a housing component (hereinafter referred to as a "module housing component") 90 that has insulating properties and houses the circuit protection unit 20 (see FIG. 1). As illustrated in FIG. 1, the module housing component 90 includes a housing chamber (hereinafter referred to as a "conductor housing chamber") 90a that houses the connection conductor 10 and a housing chamber (hereinafter referred to as a "unit housing chamber") 90b that houses the circuit protection unit 20. The conductor housing chamber 90a is provided for each of the connection conductors 10 connected to the plurality of electrode terminals BCb constituting the electrode terminal group BCc. When the wiring component 60 of the circuit protection unit 20 is formed of an electric wire, the electric wire provided for each circuit protection unit 20 is routed to a side of the battery monitoring unit in the unit housing chamber 90b. The wiring component 60 is connected to a connector CN at an end portion of the wiring component routed to a side of the battery monitoring unit. Therefore, the wiring component 60 is electrically connected to the battery monitoring unit via the connector CN. When the wiring component 60 is a flat wiring member, the unit housing chamber 90b houses the flat wiring member having a conductor portion connected to each of the second terminal fittings 50 of the plurality of circuit protection units 20 provided (not illustrated).

In addition, the module housing component 90 includes a first housing member (hereinafter referred to as a "first module housing member") 90A (see FIG. 1) and a second housing member (hereinafter referred to as a "second module housing member", which is not illustrated) that are assembled and fixed to each other to form a plurality of conductor housing chambers 90a and the unit housing chamber 90b inside. The first module housing member 90A and the second module housing member here are each formed of a material having insulating properties such as a synthetic resin. The first module housing member 90A is provided with a space portion for forming the plurality of conductor housing chambers 90a and the unit housing chamber 90b at an assembly completion position with the second module housing member. The second module housing member is formed as a cover member that covers an opening of each space portion.

The conductive module 1 described above includes the connection conductor 10 electrically connected to the electrode terminal BCb of the battery cell BC constituting the battery module BM, and the circuit protection unit 20 that electrically connects the connection conductor 10 to the battery monitoring unit that monitors a battery state of the battery cell BC. Further, the circuit protection unit 20 includes the circuit protection component 30 that fuses the fusible portion when an overcurrent flows between the connection conductor 10 and the battery monitoring unit, the first terminal fitting 40 that has the first electrical connection portion 41 electrically connected to the first electrode 31 of the circuit protection component 30 and is electrically connected to the connection conductor 10, the second terminal fitting 50 that has the second electrical connection portion 51 electrically connected to the second electrode 32 of the circuit protection component 30 and is electrically connected to the battery monitoring unit, the wiring component 60 that is interposed between the second terminal fitting 50 and the battery monitoring unit and includes the conductor portion 61 having one end electrically connected to the second terminal fitting 50 and the other end electrically connected to the battery monitoring unit, the support member 70 that has insulating properties and is formed in a plate shape and on which the first electrical connection portion 41 and the second electrical connection portion 51 are placed, and the coating resin portion 80 that has insulating properties, is provided on the support member 70, and encloses the first electrical connection portion 41, the second electrical connection portion 51, and the circuit protection component 30 installed across the first electrical connection portion 41 and the second electrical connection portion 51.

According to such a configuration, in the circuit protection unit 20 and the conductive module 1, by arranging the connection portions between the circuit protection component 30 and the pair of terminal fittings (the first terminal fitting 40 and the second terminal fitting 50) on the plate-shaped support member 70, the material cost can be suppressed as compared with the conventional circuit protection unit in which the connection portions between the circuit protection component and the pair of terminal fittings are surrounded by the frame-shaped resin portion from four direction sides. In addition, in the circuit protection unit 20 and the conductive module 1, since only a lower side (a side opposite to the circuit protection component 30) of the pair of terminal fittings is covered with the plate-shaped support member 70, it is possible to more efficiently exhaust heat generated at the connection portions between the circuit protection component 30 and the pair of terminal fittings as compared with the conventional circuit protection unit in which the connection portions between the circuit protection component and the pair of terminal fittings are surrounded by the frame-shaped resin portion from four direction sides, and thus it is possible to further curb the heat from being confined in the connection portions. In the circuit protection unit 20 and the conductive module 1, by providing the coating resin portion 80 on the plate-shaped support member 70, it is possible to suppress energization between the first electrical connection portion 41 and the second electrical connection portion 51 and to fix the circuit protection component 30, the first electrical connection portion 41, and the second electrical connection portion 51 to the support member 70. Therefore, the circuit protection unit 20 and the conductive module 1 of the present embodiment can appropriately protect the connection portions between the circuit protection component 30 and the pair of terminal fittings.

### Second Embodiment

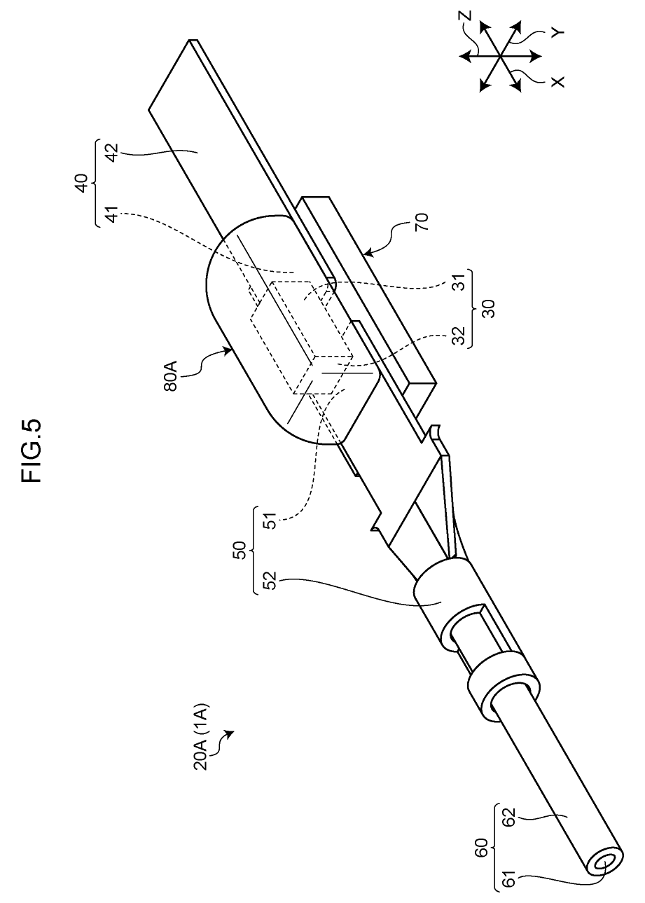

Next, a circuit protection unit 20A and a conductive module 1A according to a second embodiment illustrated in FIG. 5 will be described. The circuit protection unit 20A and the conductive module 1A are different from the circuit protection unit 20 and the conductive module 1 in the configuration of the coating resin portion 80. In the second embodiment, the same constituent elements as those in the first embodiment are denoted by the same reference numerals, and the detailed description thereof will be omitted.

Specifically, the circuit protection unit 20A applied to the conductive module 1A is different from the circuit protection unit 20 in that a coating resin portion 80A provided on the plate-shaped support member 70 is formed of a UV curable resin.

Similarly to the coating resin portion 80 described above, the coating resin portion 80A encloses the circuit protection component 30, the first electrical connection portion 41, and the second electrical connection portion 51 to suppress energization between the first electrical connection portion 41 and the second electrical connection portion 51. The coating resin portion 80A can also function as a fixing member that fixes the circuit protection component 30, the first electrical connection portion 41, and the second electrical connection portion 51 onto the support member 70 by being fixed to the support member 70.

Since the UV curable resin forming the coating resin portion 80A is a resin that is cured by being irradiated with ultraviolet rays (UV), the UV curable resin has a feature of being less likely to be dripped from the circuit protection component 30, the first electrical connection portion 41, and the second electrical connection portion 51 by being irradiated with the UV immediately after being dropped so as to enclose the circuit protection component 30, the first electrical connection portion 41, and the second electrical connection portion 51. In addition, since the UV curable resin is a resin having a relatively high curing rate, it is possible to shorten the time from when the UV curable resin is dropped so as to enclose the circuit protection component 30, the first electrical connection portion 41, and the second electrical connection portion 51 to when the UV curable resin is cured.

As described above, the conductive module 1A according to the second embodiment includes the connection conductor 10 electrically connected to the electrode terminal BCb of the battery cell BC constituting the battery module BM, and the circuit protection unit 20A that electrically connects the connection conductor 10 to the battery monitoring unit that monitors a battery state of the battery cell BC. Further, the circuit protection unit 20A includes the circuit protection component 30 that fuses the fusible portion when an overcurrent flows between the connection conductor 10 and the battery monitoring unit, the first terminal fitting 40 that has the first electrical connection portion 41 electrically connected to the first electrode 31 of the circuit protection component 30 and is electrically connected to the connection conductor 10, the second terminal fitting 50 that has the second electrical connection portion 51 electrically connected to the second electrode 32 of the circuit protection component 30 and is electrically connected to the battery monitoring unit, the wiring component 60 that is interposed between the second terminal fitting 50 and the battery monitoring unit and includes the conductor portion 61 having one end electrically connected to the second terminal fitting 50 and the other end electrically connected to the battery monitoring unit, the support member 70 that has insulating properties and is formed in a plate shape and on which the first electrical connection portion 41 and the second electrical connection portion 51 are placed, and the coating resin portion 80A that has insulating properties, is provided on the support member 70, and encloses the first electrical connection portion 41, the second electrical connection portion 51, and the circuit protection component 30 installed across the first electrical connection portion 41 and the second electrical connection portion 51. The coating resin portion 80A is formed of a UV curable resin that is cured by being irradiated with ultraviolet rays.

According to such a configuration, in the circuit protection unit 20A and the conductive module 1A, the coating resin portion 80A is formed of the UV curable resin, and the liquid resin material remaining around the first electrical connection portion 41 and the second electrical connection portion 51 installed on the plate-shaped support member 70, and the circuit protection component 30 installed across the first electrical connection portion 41 and the second electrical connection portion 51 is cured in a short time with ultraviolet rays, and thus the connection portions between the circuit protection component 30 and the pair of terminal fittings (the first terminal fitting 40 and the second terminal fitting 50) can be enclosed in a more appropriate state. Further, in the circuit protection unit 20A and the conductive module 1A, by fixing the coating resin portion 80A to the support member 70 in a short time, the circuit protection component 30, the first electrical connection portion 41, and the second electrical connection portion 51 can be fixed on the support member 70 in a more appropriate state. Therefore, the circuit protection unit 20A and the conductive module 1A can more appropriately protect the connection portions between the circuit protection component 30 and the pair of terminal fittings.

### Third Embodiment

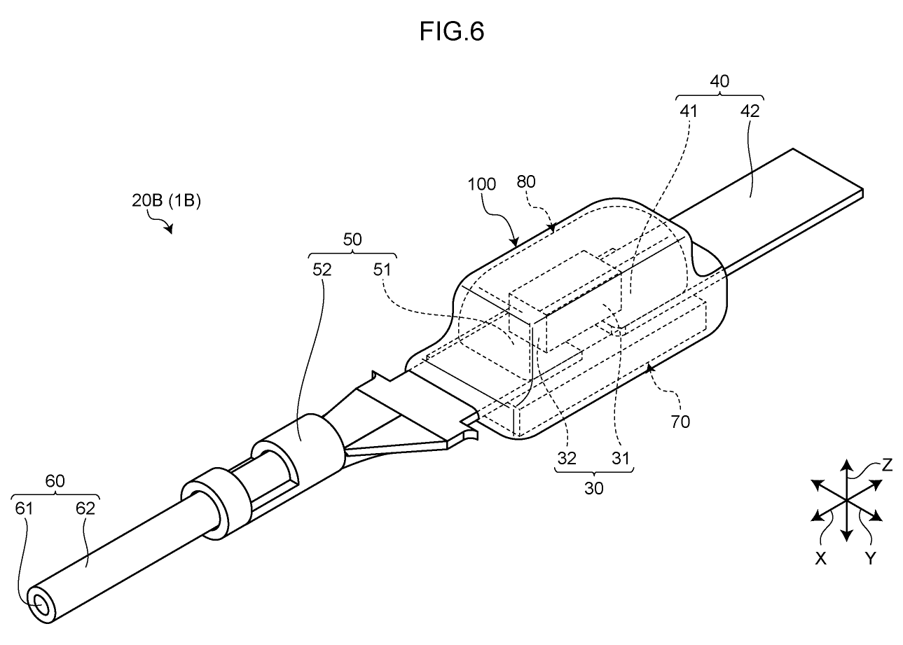

Next, a circuit protection unit 20B and a conductive module 1B according to a third embodiment illustrated in FIG. 6 will be described. The circuit protection unit 20B and the conductive module 1B are different from the circuit protection units 20 and 20A and the conductive modules 1 and 1A in that they further include a tube member that covers a portion in which the connection portions between the circuit protection component 30 and the pair of terminal fittings (the first terminal fitting 40 and the second terminal fitting 50) are enclosed by the coating resin portion 80. In the third embodiment, the same constituent elements as those in the first embodiment and the second embodiment are denoted by the same reference numerals, and the detailed description thereof will be omitted.

Specifically, the circuit protection unit 20B applied to the conductive module 1B is different from the circuit protection units 20 and 20A and the conductive modules 1 and 1A in that it further includes a heat shrinkable tube 100 that houses the first electrical connection portion 41, the second electrical connection portion 51, the circuit protection component 30, the support member 70, and the coating resin portion 80 therein and shrinks when heat is applied thereto.

The heat shrinkable tube 100 is formed of a material having insulating properties such as a synthetic resin, and houses the first electrical connection portion 41, the second electrical connection portion 51, the circuit protection component 30, the support member 70, and the coating resin portion 80 therein so as to protect the portion in which the circuit protection component 30, the first electrical connection portion 41, and the second electrical connection portion 51 are enclosed by the coating resin portion 80, in other words, the portion in which the connection portions between the circuit protection component 30 and the pair of terminal fittings (the first terminal fitting 40 and the second terminal fitting 50) are enclosed by the coating resin portion 80, from external factors such as water droplets and dust.

The heat shrinkable tube 100 is formed in a tubular shape. The cross-sectional shape of the heat shrinkable tube 100 before shrinkage (the cross-sectional shape in a direction intersecting the axial direction X which is the extending direction of the heat shrinkable tube 100) is substantially circular, and the inner diameter of the heat shrinkable tube 100 before shrinkage is set to a size allowing the heat shrinkable tube to house the first electrical connection portion 41, the second electrical connection portion 51, the circuit protection component 30, the support member 70, and the coating resin portion 80. The length (length in the axial direction X) of the heat shrinkable tube 100 before shrinkage is set to be greater than the length (length in the axial direction X) of the support member 70.

The heat shrinkable tube 100 shrinks by being subjected to a heat applying treatment (heat treatment) as described above. Therefore, when the heat shrinkable tube 100 is subjected to the heat treatment by a tool capable of applying heat such as a heat gun, the heat shrinkable tube 100 is deformed in accordance with the shapes of the support member 70 disposed therein and the coating resin portion 80 provided on the support member 70, and is brought into close contact with the support member 70 and the coating resin portion 80.

As described above, the conductive module 1B according to the third embodiment includes the connection conductor 10 electrically connected to the electrode terminal BCb of the battery cell BC constituting the battery module BM, and the circuit protection unit 20B that electrically connects the connection conductor 10 to the battery monitoring unit that monitors a battery state of the battery cell BC. Further, the circuit protection unit 20B includes the circuit protection component 30 that fuses the fusible portion when an overcurrent flows between the connection conductor 10 and the battery monitoring unit, the first terminal fitting 40 that has the first electrical connection portion 41 electrically connected to the first electrode 31 of the circuit protection component 30 and is electrically connected to the connection conductor 10, the second terminal fitting 50 that has the second electrical connection portion 51 electrically connected to the second electrode 32 of the circuit protection component 30 and is electrically connected to the battery monitoring unit, the wiring component 60 that is interposed between the second terminal fitting 50 and the battery monitoring unit and includes the conductor portion 61 having one end electrically connected to the second terminal fitting 50 and the other end electrically connected to the battery monitoring unit, the support member 70 that has insulating properties and is formed in a plate shape and on which the first electrical connection portion 41 and the second electrical connection portion 51 are placed, and the coating resin portion 80 that has insulating properties, is provided on the support member 70, and encloses the first electrical connection portion 41, the second electrical connection portion 51, and the circuit protection component 30 installed across the first electrical connection portion 41 and the second electrical connection portion 51. The circuit protection unit 20B further includes the heat shrinkable tube 100 that has insulating properties, is formed in a tubular shape, houses the first electrical connection portion 41, the second electrical connection portion 51, the circuit protection component 30, the support member 70, and the coating resin portion 80 therein, and shrinks when heat is applied thereto. The heat shrinkable tube 100 shrinks by being subjected to the heat treatment, and is brought into close contact with the support member 70 and the coating resin portion 80 provided on the support member.

According to such a configuration, in the circuit protection unit 20B and the conductive module 1B, the heat shrinkable tube 100 is shrunk by the heat treatment, and is brought into close contact with the plate-shaped support member 70 housed inside the heat shrinkable tube 100 and the coating resin portion 80 provided on the support member 70, and thus the portion in which the connection portions between the circuit protection component 30 and the pair of terminal fittings (the first terminal fitting 40 and the second terminal fitting 50) are enclosed by the coating resin portion 80 can be protected. Therefore, in the circuit protection unit 20B and the conductive module 1B, since the connection portions between the circuit protection component 30 and the pair of terminal fittings can be protected by the two members of the coating resin portion 80 and the heat shrinkable tube 100, the connection portions between the circuit protection component 30 and the pair of terminal fittings can be more appropriately protected. Further, in the circuit protection unit 20B and the conductive module 1B, by bringing the heat shrinkable tube 100 into close contact with the support member 70 and the coating resin portion 80, it is possible to suppress application of heat from the heat gun or the like to the connection portions between the circuit protection component 30 and the pair of terminal fittings when the heat shrinkable tube 100 is subjected to the heat treatment. Further, in the circuit protection unit 20B and the conductive module 1B, by bringing the heat shrinkable tube 100 into close contact with the support member 70 and the coating resin portion 80, it is possible to absorb heat generated at the connection portions between the circuit protection component 30 and the pair of terminal fittings and radiate the heat to the outside via the heat shrinkable tube 100, and thus it is possible to curb the heat from being confined in the connection portions. In the circuit protection unit 20B and the conductive module 1B, since the heat shrinkable tube 100 can be used as the tube member that covers the portion in which the connection portions between the circuit protection component 30 and the pair of terminal fittings are enclosed by the coating resin portion 80, an existing product can be used, and thus productivity can be improved and manufacturing cost can be suppressed. Therefore, the circuit protection unit 20B and the conductive module 1B can more appropriately protect the connection portions between the circuit protection component 30 and the pair of terminal fittings.

### Fourth Embodiment

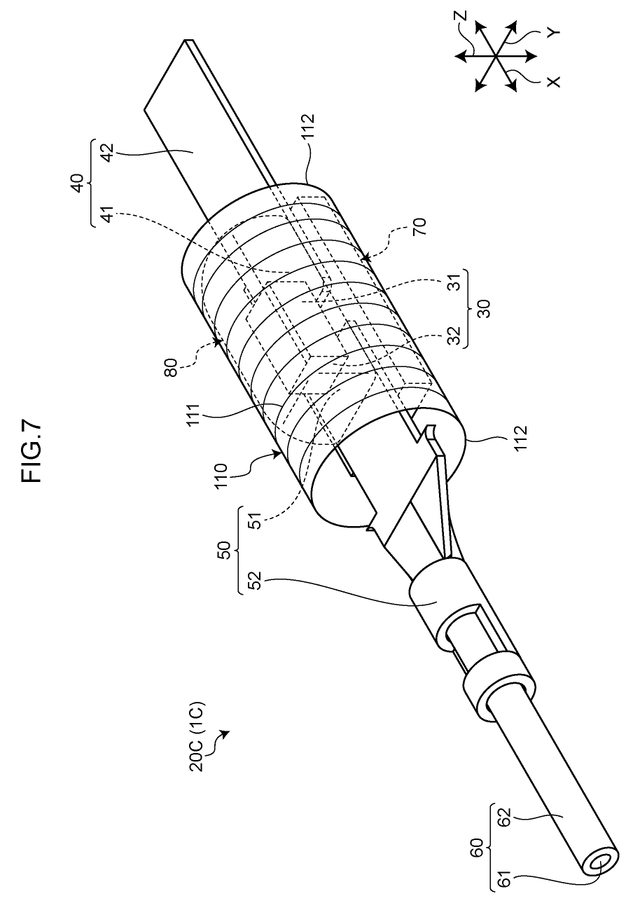

Next, a circuit protection unit 20C and a conductive module 1C according to a fourth embodiment illustrated in FIG. 7 will be described. The circuit protection unit 20C and the conductive module 1C are different from the circuit protection units 20 and 20A and the conductive modules 1 and 1A in that they further include a tube member that covers a portion in which the connection portions between the circuit protection component 30 and the pair of terminal fittings (the first terminal fitting 40 and the second terminal fitting 50) are enclosed by the coating resin portion 80. The circuit protection unit 20C and the conductive module 1C are different from the circuit protection unit 20B and the conductive module 1B in the configuration of the tube member. In the fourth embodiment, the same constituent elements as those in the first embodiment, the second embodiment, and the third embodiment are denoted by the same reference numerals, and the detailed description thereof will be omitted.

Specifically, the circuit protection unit 20C applied to the conductive module 1C is different from the circuit protection units 20, 20A, and 20B and the conductive modules 1, 1A, and 1B in that it further includes a rigid tube 110 that houses the first electrical connection portion 41, the second electrical connection portion 51, the circuit protection component 30, the support member 70, and the coating resin portion 80 therein.

The rigid tube 110 is formed of a material having insulating properties such as a synthetic resin, and houses the first electrical connection portion 41, the second electrical connection portion 51, the circuit protection component 30, the support member 70, and the coating resin portion 80 therein so as to protect the portion in which the circuit protection component 30, the first electrical connection portion 41, and the second electrical connection portion 51 are enclosed by the coating resin portion 80, in other words, the portion in which the connection portions between the circuit protection component 30 and the pair of terminal fittings (the first terminal fitting 40 and the second terminal fitting 50) are enclosed by the coating resin portion 80, from external factors such as water droplets and dust. The rigid tube 110 of the present embodiment is a corrugated tube.

The rigid tube 110 is formed in a tubular shape. The cross-sectional shape of the rigid tube 110 (the cross-sectional shape in a direction intersecting the axial direction X which is an extending direction of the rigid tube 110) is substantially circular, and the inner diameter of the rigid tube 110 is set to a size allowing the rigid tube to house the first electrical connection portion 41, the second electrical connection portion 51, the circuit protection component 30, the support member 70, and the coating resin portion 80. The length (length in the axial direction X) of the rigid tube 110 is set to be greater than the length (length in the axial direction X) of the support member 70.

In the rigid tube 110, an annular uneven portion 111 is formed on the outer surface in a circumferential direction, and a plurality of uneven portions 111 is provided in the extending direction of the rigid tube 110 to form a bellows shape. Therefore, the rigid tube 110 includes, as the uneven portion 111, a convex portion protruding toward an outer circumferential surface side and a concave portion protruding toward an inner circumferential surface side. In addition, the rigid tube 110 has flexibility and is deformed into an elliptical shape or the like in accordance with the height and width of the support member 70 housed therein and the coating resin portion 80 provided on the support member 70.

As described above, the conductive module 1C according to the fourth embodiment includes the connection conductor 10 electrically connected to the electrode terminal BCb of the battery cell BC constituting the battery module BM, and the circuit protection unit 20C that electrically connects the connection conductor 10 to the battery monitoring unit that monitors a battery state of the battery cell BC. Further, the circuit protection unit 20C includes the circuit protection component 30 that fuses the fusible portion when an overcurrent flows between the connection conductor 10 and the battery monitoring unit, the first terminal fitting 40 that has the first electrical connection portion 41 electrically connected to the first electrode 31 of the circuit protection component 30 and is electrically connected to the connection conductor 10, the second terminal fitting 50 that has the second electrical connection portion 51 electrically connected to the second electrode 32 of the circuit protection component 30 and is electrically connected to the battery monitoring unit, the wiring component 60 that is interposed between the second terminal fitting 50 and the battery monitoring unit and includes the conductor portion 61 having one end electrically connected to the second terminal fitting 50 and the other end electrically connected to the battery monitoring unit, the support member 70 that has insulating properties and is formed in a plate shape and on which the first electrical connection portion 41 and the second electrical connection portion 51 are placed, and the coating resin portion 80 that has insulating properties, is provided on the support member 70, and encloses the first electrical connection portion 41, the second electrical connection portion 51, and the circuit protection component 30 installed across the first electrical connection portion 41 and the second electrical connection portion 51. The circuit protection unit 20C further includes the rigid tube 110 that has insulating properties, is formed in a tubular shape, and houses the first electrical connection portion 41, the second electrical connection portion 51, the circuit protection component 30, the support member 70, and the coating resin portion 80 therein.

According to such a configuration, in the circuit protection unit 20C and the conductive module 1C, since the periphery of the plate-shaped support member 70 and the coating resin portion 80 provided on the support member 70 can be surrounded by the rigid tube 110, the portion in which the connection portions between the circuit protection component 30 and the pair of terminal fittings (the first terminal fitting 40 and the second terminal fitting 50) are enclosed by the coating resin portion 80 can be protected. Therefore, in the circuit protection unit 20C and the conductive module 1C, since the connection portions between the circuit protection component 30 and the pair of terminal fittings can be protected by the two members of the coating resin portion 80 and the rigid tube 110, the connection portions between the circuit protection component 30 and the pair of terminal fittings can be more appropriately protected. Further, in the circuit protection unit 20C and the conductive module 1C, it is possible to absorb heat generated at the connection portions between the circuit protection component 30 and the pair of terminal fittings and radiate the heat to the outside through openings 112 (a pair of openings 112 opened in the axial direction X) of the rigid tube 110 formed in a tubular shape, and thus it is possible to curb the heat from being confined in the connection portions. In addition, in the circuit protection unit 20C and the conductive module 1C, since the corrugated tube is used as the rigid tube 110, the area in contact with the external fluid can be increased by the uneven portion 111 of the corrugated tube, and thus it is possible to further curb the heat from being confined in the connection portions. In the circuit protection unit 20C and the conductive module 1C, since the rigid tube 110 can be used as the tube member that covers the portion in which the connection portions between the circuit protection component 30 and the pair of terminal fittings are enclosed by the coating resin portion 80, an existing product can be used, and thus productivity can be improved and manufacturing cost can be suppressed. Therefore, the circuit protection unit 20C and the conductive module 1C can more appropriately protect the connection portions between the circuit protection component 30 and the pair of terminal fittings.

Note that the circuit protection units 20, 20A, 20B, and 20C and the conductive modules 1, 1A, 1B, and 1C according to the above-described embodiments of the present invention are not limited to the above-described embodiments, and various modifications can be made within the scope described in the claims.

For example, the shape of the support member 70 is not particularly limited to the rectangular shape as illustrated in FIG. 3. The shape of the support member 70 may be, for example, a shape including a straight line and a curved line such as a polygon or an oval.

Further, the support member 70 may be formed integrally with the first module housing member 90A.

The rigid tube 110 is not limited to a corrugated tube. The rigid tube 110 may be, for example, a tube member (for example, a twist tube) that is not formed in a bellows shape.

Further, the circuit protection units 20, 20A, 20B, and 20C may be applied to, for example, an electrical junction box. The circuit protection units 20, 20A, 20B can be installed at any position on the electric circuit.

Further, the circuit protection units 20, 20A, 20B, and 20C and the conductive modules 1, 1A, 1B, and 1C according to the present embodiment may be configured by appropriately combining the constituent elements of the embodiments described above.

### Reference Example of Second Embodiment

As a reference example of the second embodiment, the circuit protection unit 20A and the conductive module 1A may be configured not to include the support member 70 in some cases depending on, for example, a case where the positional relationship between the first terminal fitting 40 and the second terminal fitting 50 is already fixed in the manufacturing process. That is, in this case, the circuit protection unit 20A and the conductive module 1A include the circuit protection component 30, the first terminal fitting 40, the second terminal fitting 50, the wiring component 60, and the coating resin portion 80A. Even in this case, in the circuit protection unit 20A and the conductive module 1A according to the reference example, the liquid resin material remaining around the circuit protection component 30, the first electrical connection portion 41, and the second electrical connection portion 51 is cured in a short time with ultraviolet rays, and thus the connection portions between the circuit protection component 30 and the pair of terminal fittings (the first terminal fitting 40 and the second terminal fitting 50) can be enclosed in an appropriate state in some cases. Therefore, the circuit protection unit 20A and the conductive module 1A according to the reference example can appropriately protect the connection portions between the circuit protection component 30 and the pair of terminal fittings.

### Reference Example of Third Embodiment

As a reference example of the third embodiment, for example, the circuit protection unit 20B and the conductive module 1B may be configured not to include the support member 70 and the coating resin portion 80 in some cases depending on a case where the first electrical connection portion 41 and the second electrical connection portion 51 are insulated by other means, a state of an installation position of each portion constituting the circuit protection unit 20B, or the like. That is, in this case, the circuit protection unit 20B and the conductive module 1B include the circuit protection component 30, the first terminal fitting 40, the second terminal fitting 50, the wiring component 60, and the heat shrinkable tube 100. Even in this case, in the circuit protection unit 20B and the conductive module 1B according to the reference example, by bringing the heat shrinkable tube 100 into close contact with the circuit protection component 30, the first electrical connection portion 41, and the second electrical connection portion 51, the connection portions between the circuit protection component 30 and the pair of terminal fittings (the first terminal fitting 40 and the second terminal fitting 50) housed therein can be protected in some cases. In addition, in the circuit protection unit 20B and the conductive module 1B according to the reference example, it is possible to curb the heat from being confined in the connection portions between the circuit protection component 30 and the pair of terminal fittings through the heat shrinkable tube 100 in some cases. Therefore, the circuit protection unit 20B and the conductive module 1B according to the reference example can appropriately protect the connection portions between the circuit protection component 30 and the pair of terminal fittings.

### Reference Example of Fourth Embodiment

As a reference example of the fourth embodiment, for example, the circuit protection unit 20C and the conductive module 1C may be configured not to include the support member 70 and the coating resin portion 80 in some cases depending on a case where the first electrical connection portion 41 and the second electrical connection portion 51 are insulated by other means, a state of an installation position of each portion constituting the circuit protection unit 20C, or the like. That is, in this case, the circuit protection unit 20C and the conductive module 1C include the circuit protection component 30, the first terminal fitting 40, the second terminal fitting 50, the wiring component 60, and the rigid tube 110. Even in this case, in the circuit protection unit 20C and the conductive module 1C according to the reference example, it is possible to curb the heat from being confined in the connection portions between the circuit protection component 30 and the pair of terminal fittings through the openings 112 of the rigid tube 110 formed in a tubular shape in some cases. In addition, in the circuit protection unit 20C and the conductive module 1C according to the reference example, since the corrugated tube is used as the rigid tube 110, the area in contact with the external fluid can be increased by the uneven portion 111 of the corrugated tube, and thus it is possible to curb the heat from being confined in the connection portions in some cases. Therefore, the circuit protection unit 20C and the conductive module 1C according to the reference example can appropriately protect the connection portions between the circuit protection component 30 and the pair of terminal fittings.

The circuit protection unit and the conductive module according to the present embodiments achieve an effect of being capable of appropriately protecting the connection portions between the circuit protection component and the pair of terminal fittings.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A circuit protection unit comprising:
a circuit protection component that fuses a fusible portion when an overcurrent flows between a first electrical connection target and a second electrical connection target;
a first terminal fitting that has a first electrical connection portion electrically connected to a first electrode of the circuit protection component and is electrically connected to the first electrical connection target;
a second terminal fitting that has a second electrical connection portion electrically connected to a second electrode of the circuit protection component and is electrically connected to the second electrical connection target;
a support member that has insulating properties and is formed in a plate shape and on which the first electrical connection portion and the second electrical connection portion are placed; and
a coating resin portion that has insulating properties, is provided on the support member, and encloses the first electrical connection portion, the second electrical connection portion, and the circuit protection component installed across the first electrical connection portion and the second electrical connection portion.

2. The circuit protection unit according to claim 1, wherein
the coating resin portion is formed of a UV curable resin that is cured by being irradiated with ultraviolet rays.

3. The circuit protection unit according to claim 1, further comprising:
a heat shrinkable tube that has insulating properties, is formed in a tubular shape, houses the first electrical connection portion, the second electrical connection portion, the circuit protection component, the support member, and the coating resin portion therein, and shrinks when heat is applied thereto, wherein
the heat shrinkable tube shrinks by being subjected to a heat treatment, and is brought into close contact with the support member and the coating resin portion provided on the support member.

4. The circuit protection unit according to claim 1, further comprising:
a rigid tube that has insulating properties, is formed in a tubular shape, and houses the first electrical connection portion, the second electrical connection portion, the circuit protection component, the support member, and the coating resin portion therein.

5. A conductive module comprising:
a connection conductor electrically connected to an electrode terminal of a battery cell constituting a battery module; and
a circuit protection unit that electrically connects the connection conductor to a battery monitoring unit that monitors a battery state of the battery cell, wherein
the circuit protection unit includes:
a circuit protection component that fuses a fusible portion when an overcurrent flows between the connection conductor and the battery monitoring unit;
a first terminal fitting that has a first electrical connection portion electrically connected to a first electrode of the circuit protection component and is electrically connected to the connection conductor;
a second terminal fitting that has a second electrical connection portion electrically connected to a second electrode of the circuit protection component and is electrically connected to the battery monitoring unit;
a wiring component that is interposed between the second terminal fitting and the battery monitoring unit and includes a conductor portion having one end electrically connected to the second terminal fitting and another end electrically connected to the battery monitoring unit;
a support member that has insulating properties and is formed in a plate shape and on which the first electrical connection portion and the second electrical connection portion are placed; and
a coating resin portion that has insulating properties, is provided on the support member, and encloses the first electrical connection portion, the second electrical connection portion, and the circuit protection component installed across the first electrical connection portion and the second electrical connection portion.
